(19) United States
(12) Patent Application Publication
(10) Pub. No.: US 2003/0100426 A1
(43) Pub. Date: May 29, 2003

(54) Method for producing semi-transparent lamp shades from the unsaturated resin

(76) Inventor: Jerry Lin, Taichung (TW)

Correspondence Address: Kuo-Hsiung Chiu, 13F. No. 23, Jiun-Ho Street, Peitun District, Taichung, 406, TW

(21) Appl. No.: 09/994,453

(22) Filed: Nov. 28, 2001

(51) Int. Cl. B31B 1/00

(52) U.S. Cl. 493/950; 493/480

(57) ABSTRACT

The present invention relates to a method for producing semi-transparent lampshades from the unsaturated resin. A mold of the lampshade to be completed is produced first, then a first layer of the unsaturated resin to the inner side of the mold is painted. Thereafter, a layer of glass fiber to the first layer of the unsaturated resin is stuck. Again, a second layer of the unsaturated resin to the glass fiber layer is painted. Finally, the lampshade from the mold after the material is solidified is removed.

### BACKGROUND OF THE INVENTION

1. Field of the Invention

The present invention relates to a method for producing semi-transparent lamp shades, and more particularly, to a method for producing semi-transparent lamp shades from the unsaturated resin in combination with a certain amount of glass fiber in order to reach the structural ductility and to have an optimal impact strength due to the application of the unsaturated resin while a semi-transparent effect is achievable due to the application of the glass fiber.

2. Description of the Prior Art

The conventional lampshades can be transparent, semitransparent and nontransparent, and this is completely dependent on the manufacturing material. The lampshades produced from the glass fiber will obtain a full transparency and are, however, fragile and have bad impact strength. The lampshades produced from cloth, paper material, plastics, etc. have the semitransparent effect; however, the resistance for heat, moisture, impact, dirt, etc. is not enough. Besides, the service life is also shorter. The lampshades produced from the unsaturated resin are totally nontransparent so that the beauty of the light can't be shown; however, it has the best durability among all materials.

The lampshades produced from the unsaturated resin are totally nontransparent since a certain amount of mountain flour has to be added to the material in order to have the rigid feature after the unsaturated resin is hardened so that the mountain flour serves as fortifying agent. Thus, the lampshades can be kept in certain form. The mountain flour can't be given up, thereby causing the nontransparency of the lampshades.

As described, the lampshade produced from the unsaturated resin is excellent in structural strength, corrosion resistance, water resistance, wear resistance and service life. Thus, how to improve the lampshade produced from the unsaturated resin to have proper light transmission and to show the beauty of light is the main topic of the present invention.

### DETAILED DESCRIPTION OF THE PREFERRED EMBODIMENT

The process of the present invention is described as follows:

a) To produce a mold of the lamp shade to be completed;

b) To paint a first layer of the unsaturated resin to the inner side of the mold;

c) To stick a layer of glass fiber to the first layer of the unsaturated resin in order to strengthen the structure;

d) To paint a second layer of the unsaturated resin to the glass fiber layer;

e) To remove the lampshade from the mold after the material is solidified.

Of course, the thickness of the lampshade can be increased according to the different requirements by means of repetition of the procedure c) and d).

Based upon the combination of the unsaturated resin and the glass fiber, the excellent features of the unsaturated resin and the glass fiber can be integrated to complete a lampshade with proper structural strength and the light transmission.

The change the light transmission and light transmitting color can be reached by the follow-up painting. For example, the light color paint can reach a better light transmission. To the contrary, the dark color paint will give a worse light transmission. Different color of paints will create different light transmission as well.

Many changes and modifications in the above-described embodiments of the invention can, of course, be carried out without departing from the scope thereof. Accordingly, to promote the progress in science and the useful arts, the invention is disclosed and is intended to be limited only by the scope of the appended claims.

What is claimed is:

1. A method for producing semi-transparent lamp shades from the unsaturated resin, the method comprising:
a) producing a mold of the lamp shade to be completed;
b) painting a first layer of the unsaturated resin to the inner side of said mold;
c) sticking a layer of glass fiber to said first layer of said unsaturated resin in order to strengthen the structure;
d) painting a second layer of the unsaturated resin to said glass fiber layer, and
e) removing said lampshade from said mold after the material is solidified.

2. The method of claim 1, wherein the thickness of said lamp shades can be increased according to the different requirements.
